(19) United States
(12) Patent Application Publication
(10) Pub. No.: US 2023/0054520 A1
(43) Pub. Date: Feb. 23, 2023

(54) STAND FOR PEAKED ROOF AND THE LIKE

(71) Applicant: Philip ALFIERI, Islip, NY (US)

(72) Inventor: Philip ALFIERI, Islip, NY (US)

(21) Appl. No.: 17/820,466

(22) Filed: Aug. 17, 2022

Related U.S. Application Data
(60) Provisional application No. 63/260,362, filed on Aug. 18, 2021.

(51) Int. Cl. A47B 3/08; A47B 5/06

(52) U.S. Cl. CPC A47B 3/0803; A47B 5/06

(57) ABSTRACT

A stand providing a horizontal support surface upon a sloping peak includes a central support having a top surface and bottom surface with opposing end portions, and adjustably extendible legs attached in spaced relation to the bottom surface of the central support and end supports. The central support and end supports are connected by a hinge having a range of motion limiting upward movement of the end supports to a horizontal position with the central support. Each of the central and end supports have spaced adjustably extendible legs attached to the bottom surface whereby the central support and the respective end supports can be aligned to provide a horizontal support surface on a sloping peak by adjustment of said extendible legs, regardless of the angles of declination from the peak.

### CROSS-REFERENCE TO RELATED APPLICATION

This application claims the benefit of U.S. Provisional Application Ser. No. 63/260,362, filed Aug. 18, 2021. The disclosures, drawings and descriptions thereof are hereby incorporated by this reference.

### FIELD OF THE INVENTION

The present invention relates to readily compactable stands that may be placed on a peaked surface such as a roof top to provide a horizontal support surface regardless of the pitch or declination of the meeting peaked surfaces and will not damage the peaked surface.

### BACKGROUND OF THE INVENTION

Supports that may be placed on a sloping roof to support such items as paint cans are well known, and typically have structures to enable the support to provide a horizontal support surface for varying roof angles. Such items, are disclosed in U.S. Pat. Nos. 612,256; 1,267,056; 1,363,864; 2,623,794; 4,450,935; and 5,474,271. While such supports made be held to sloping roofs of varying degrees of declination, and some may easily be compacted and can be used without damaging the roof, they are not, however, readily suitable for use on the peak of mating sloping surfaces, such as a roof top.

It is, therefore, an object of the present invention to provide a stand for a peaked surface such as a roof top that provides a horizontal support surface regardless of the pitch or declination of the meeting peaked surfaces that can also readily compacted for storage and transport, is easy to assemble and use and yet will not damage the peaked surface.

### SUMMARY OF THE INVENTION

These and other objects, features and advantages of the present invention are provided by a stand providing a horizontal support surface upon a sloping peak, such as a roof top, regardless of the angles of declination from the peak, that includes a central support having a top surface and bottom surface with opposing end portions with adjustably extendible legs attached in spaced relation to the bottom surface of each end portion. Respective end supports having a top surface and bottom surface are attached by a hinge to a respective end portion, and this hinge preferably has a range of motion limiting upward movement of the end supports to a horizontal position with the central support.

Each of the end supports has spaced adjustably extendible legs attached to the bottom surface of each end portion. In this way, the central support and respective end supports can be aligned to provide a horizontal support surface on a sloping peak by adjustment of the extendible legs quickly and easily, without any need to use screws or other fasteners that may damage the roof area.

### BRIEF DESCRIPTION OF THE DRAWINGS

FIG. 1 is a top view of the stand of the present invention;

FIG. 2 is a side view thereof:

FIG. 3 illustrates a partially folded condition of the stand of the present invention;

FIG. 4 illustrates a fully folded condition of the stand of the present invention.

### DETAILED DESCRIPTION OF A PREFERRED EMBODIMENT

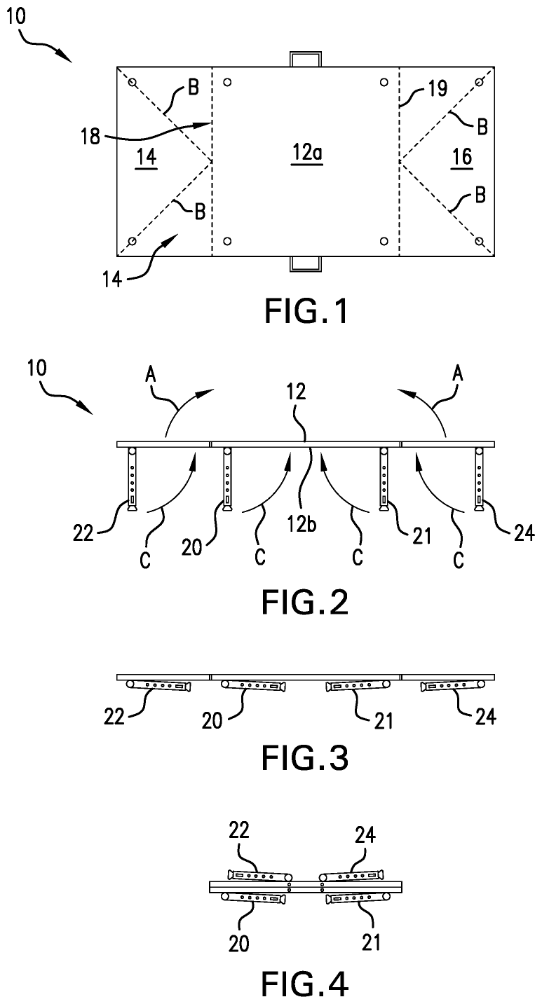

The stand 10 of an embodiment of the present invention is shown in FIGS. 1 and 2 and includes a stand 10 formed of a rigid plastics material including a central support 12 having a top surface 12a and a bottom surface 12b. The central support has opposing end supports 14 and 16 connected by a hinge structures 18 and 19 that have a range of motion limiting upward movement so that these end supports 14 and 16 can be easily and quickly brought into a horizontal position with the central support 12 as shown in FIG. 2. Such hinge structures are preferably piano hinges extending along the junctions of the central support 12 with the end supports 14 and 16.

Four legs, two of which 20 and 21 are illustrated in FIG. 2 are attached to the four corners of the bottom surface 12b of the central support 12, directly below the hinge structures 18 and 19. Each of these legs is retractable in height by having telescoping inserts with pin-in-hole adjustments as well understood in the art. The legs each have elastomeric swivel feet to adjust for being seated on a sloping surface.

As illustrated by the arrows “A,” the end supports 14 and 16 can be pivoted as leafs upwardly around the hinges 18 and 19 to lie adjacent the top surface 12a of the central support 12 as shown in the compact position of FIG. 4. Clamps can be provided to secure the end supports 14 and 16 in this position.

Two legs, one of which 22 and 24 are illustrated in FIG. 2 are attached to the end corners of the respective end supports 14 and 16. Each of these legs is retractable in height by having telescoping inserts with pin-in-hole adjustments as well understood in the art. The legs also have elastomeric swivel feet to adjust for being seated on a sloping surface, and are mounted to be pivoted under the end supports 14 and 16 at an angle as shown in dotted lines “B”.

As shown in FIG. 3, the legs can be pivoted in the direction of arrows “C” into engagement with the undersurface of the stand 10 and held in position by clamps, and then the end supports 14 and 16 folded as shown in FIG. 4 to provide a compact carrying and storage position for the stand 10.

As can be understood, the stand 10 can be positioned upon a peaked roof or the like and regardless of the pitch or declination of the sloping sides, the adjustable legs can be position and adjusted in height to provide a stable horizontal surface by the central support 12 and end supports 14 and 16 being brought into horizontal engagement with the legs properly adjusted in height.

What is claimed is:

1. A stand for providing a horizontal support surface upon a sloping peak regardless of the angles of declination from the peak, including a central support having a top surface and bottom surface with opposing end portions, at least one adjustably extendible leg attached to the bottom surface of each end portion, and respective end supports having a top surface and bottom surface and attached by a hinge to a respective end portions, each of said end supports having at least one adjustably extendible leg attached to the bottom surface of each end portion whereby said central support and said respective end supports can be aligned to provide a horizontal support surface on a sloping peak by adjustment of said extendible legs.

2. A stand as set forth in claim 1, each said hinge having a range of motion limiting upward movement of said end supports to a horizontal position with said central support.

3. A stand as set forth in claim 2, including two adjustably extendible legs attached in spaced relation to the bottom surface of each end portion.

4. A stand as set forth in claim 3, said two adjustably extendible legs attached by a hinge to the bottom surface of each end portion so as to be pivoted into engagement with said respective end portion.

5. A stand as set forth in claim 2, including two adjustably extendible legs attached in spaced relation to the bottom surface of each end support.

6. A stand as set forth in claim 5, said two adjustably extendible legs attached by a hinge to the bottom surface of each end support so as to be pivoted into engagement with said respective end portion.

7. A stand as set forth in claim 1, including two adjustably extendible legs attached in spaced relation to the bottom surface of each end portion.

8. A stand as set forth in claim 7, said two adjustably extendible legs attached by a hinge to the bottom surface of each end portion so as to be pivoted into engagement with said respective end portion.

9. A stand as set forth in claim 1, including two adjustably extendible legs attached in spaced relation to the bottom surface of each end support.

10. A stand as set forth in claim 9, said two adjustably extendible legs attached by a hinge to the bottom surface of each end support so as to be pivoted into engagement with said respective end portion.

11. A stand for providing a horizontal support surface upon a sloping peak regardless of the angles of declination from the peak, including a central support having a top surface and bottom surface with opposing end portions, adjustably extendible legs attached in spaced relation to the bottom surface of each end portion, and respective end supports having a top surface and bottom surface and attached by a hinge to a respective end portion, said hinge having a range of motion limiting upward movement of said end supports to a horizontal position with said central support, each of said end supports having spaced adjustably extendible leg attached to the bottom surface of each end portion whereby said central support and said respective end supports can be aligned to provide a horizontal support surface on a sloping peak by adjustment of said extendible legs.
